(19) United States
(12) Patent Application Publication
(10) Pub. No.: US 2026/0331670 A1
(43) Pub. Date: Oct. 22, 2026

(54) COOLER AND MANUFACTURING METHOD OF BATTERY PACK

(71) Applicant: TOYOTA JIDOSHA KABUSHIKI KAISHA, Toyota-shi (JP)

(72) Inventor: Osamu YAMASHITA, Toyota-shi (JP)

(73) Assignee: TOYOTA JIDOSHA KABUSHIKI KAISHA, Toyota-shi (JP)

(21) Appl. No.: 19/351,878

(22) Filed: Oct. 7, 2025

(30) Foreign Application Priority Data
Oct. 17, 2024 (JP) 2024-182162

(51) Int. Cl. H01M 50/242; H01M 10/613; H01M 10/647; H01M 10/6555; H01M 50/204; H01M 50/291

(52) U.S. Cl. CPC H01M 50/242; H01M 10/613; H01M 10/647; H01M 10/6555; H01M 50/204; H01M 50/291

(57) ABSTRACT

A cooler stacked alternately with batteries and cooling the batteries includes a cooling portion arranged between adjacent batteries in a stacking direction, in which the cooling portion includes a channel through which a coolant flows, a first cooling face in contact with one of the batteries, a second cooling face-in contact with another of the batteries, a first protrusion protruding in the stacking direction from a rear face of the first cooling face toward a rear face of the second cooling face, and a second protrusion protruding in the stacking direction from the rear face of the second cooling face toward the first cooling face. The channel is fashioned from an internal space in which the rear faces of the cooling faces face each other, and when the first and second cooling faces are in facial contact with the batteries, the first and the second protrusions face each other.

### CROSS-REFERENCE TO RELATED APPLICATION

This application claims priority to Japanese Patent Application No. 2024-182162 filed on Oct. 17, 2024. The disclosure of the above-identified application, including the specification, drawings, and claims, is incorporated by reference herein in its entirety.

### BACKGROUND

### 1. Technical Field

The present disclosure relates to a cooler and to a manufacturing method of a battery pack.

### 2. Description of Related Art

Japanese Unexamined Patent Application Publication (Translation of PCT Application) No. 2024-509489 (JP 2024-509489 A) discloses a battery pack, in which a cooling device for cooling battery cells is provided inside a case that houses a plurality of battery cells. In a configuration described in JP 2024-509489 A, the cooling device has a plurality of coolers, and the coolers and the battery cells are stacked alternately.

### SUMMARY

In a structure in which the battery cells and the coolers are stacked alternately as in the configuration described in JP 2024-509489 A, the battery cells expand during use, deforming and thereby compressing the coolers. In this case, when the coolers are significantly compressed, channels for coolant that are provided inside the coolers become narrow, and cooling performance deteriorates.

The present disclosure has been made in consideration of the above circumstances, and an object thereof is to provide a cooler and a method for manufacturing a battery pack that can suppress the channels for the coolant from being crushed by batteries expanding during use, thereby securing cooling performance.

A cooler according to the present disclosure is stacked alternately with batteries and cools the batteries, the cooler including a cooling portion that is arranged between adjacent batteries in a stacking direction, in which the cooling portion includes a channel through which a coolant flows, a first cooling face that is a cooling face that is in contact with one of the batteries, a second cooling face that is a cooling face that is in contact with another of the batteries, a first protrusion that protrudes in the stacking direction from a rear face of the first cooling face toward a rear face of the second cooling face, and a second protrusion that protrudes in the stacking direction from the rear face of the second cooling face toward the rear face of the first cooling face, the channel is fashioned from an internal space in which the rear faces of the cooling faces face each other, and when the first cooling face and the second cooling face are in facial contact with the batteries, the first protrusion and the second protrusion face each other in the stacking direction, inside the cooling portion.

A manufacturing method of a battery pack according to the present disclosure includes the cooler according to the above disclosure, the manufacturing method including disposing the battery cells between adjacent coolers, in a state in which a cooling device that is fabricated of a plurality of the coolers such that the cooling faces of the coolers face each other, is placed inside a case that houses the battery cells, and increasing internal pressure of the coolers following the battery cells being disposed between the coolers, and deforming the coolers such that the cooling faces come into contact with the battery cells, in which inside of each of the coolers prior to deformation in the disposing, the first protrusion and the second protrusion do not face each other in the stacking direction, and inside of each of the coolers following deformation in the deforming, the first protrusion and the second protrusion face each other in the stacking direction.

In the present disclosure, a channel for a coolant can be suppressed from being crushed by batteries that expand during use, and cooling performance can be secured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a battery pack according to an embodiment;

FIG. 2 is a diagram for describing a cooling device;

FIG. 3 is a diagram for describing a cooler;

FIG. 4 is a diagram for describing a cooling portion;

FIG. 5 is a diagram in which a portion (a) is a diagram for describing a shape in a state of having been formed by extrusion molding, a portion (b) is a diagram for describing a shape partway through deformation that is caused by pressure being applied inside the cooler, and a portion (c) is a diagram for describing a shape following deformation that is caused by pressure being applied inside the cooler;

FIG. 6 is a diagram for describing a state in which protrusions support each other inside the cooling portion when battery cells expand during use;

FIG. 7 is a diagram in which a portion (a) is a diagram for describing a disposing step, a portion (b) is a diagram for describing a deformation step in progress, and a portion (c) is a diagram for describing a state following the deformation step being completed;

FIG. 8A is a diagram for describing a structure in which a corner portion has a thin-walled portion;

FIG. 8B is a diagram for describing another shape of the thin-walled portion; and

FIG. 8C is a diagram for describing yet another shape of the thin-walled portion.

### DETAILED DESCRIPTION OF EMBODIMENTS

A manufacturing method of a cooler and a battery pack according to an embodiment of the present disclosure will be described below in detail. It should be noted that the present disclosure is not limited to the embodiment that is described below.

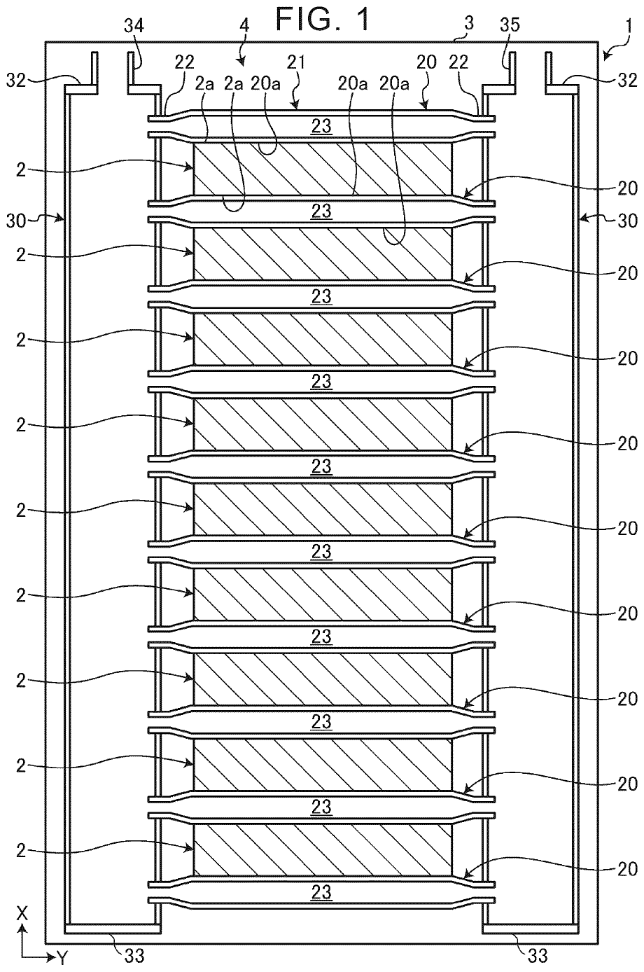

FIG. 1 is a schematic diagram of a battery pack according to the embodiment. The battery pack 1 includes a plurality of battery cells 2, a case 3, and a cooling device 4. The battery pack 1 is installed in an electrified vehicle. The electrified vehicle that is equipped with the battery pack 1 travels by supplying electric power that is stored in the battery pack 1 to a traction motor.

The battery cells 2 are batteries that are formed as cuboids. The battery cells 2 includes flat faces 2a that have the largest area among surfaces thereof. The battery cells 2 are arranged inside the case 3 with the flat faces 2a facing an X direction. The X direction is a first direction. Inside the case 3, the battery cells 2 are stacked in the X direction.

The case 3 houses the battery cells 2 and the cooling device 4. Inside the case 3, the battery cells 2 make up a battery module. The case 3 is a battery pack case that houses a plurality of the battery modules.

The cooling device 4 cools the battery cells 2 by a coolant. The cooling device 4 includes a plurality of coolers 20 and a pair of pipes 30.

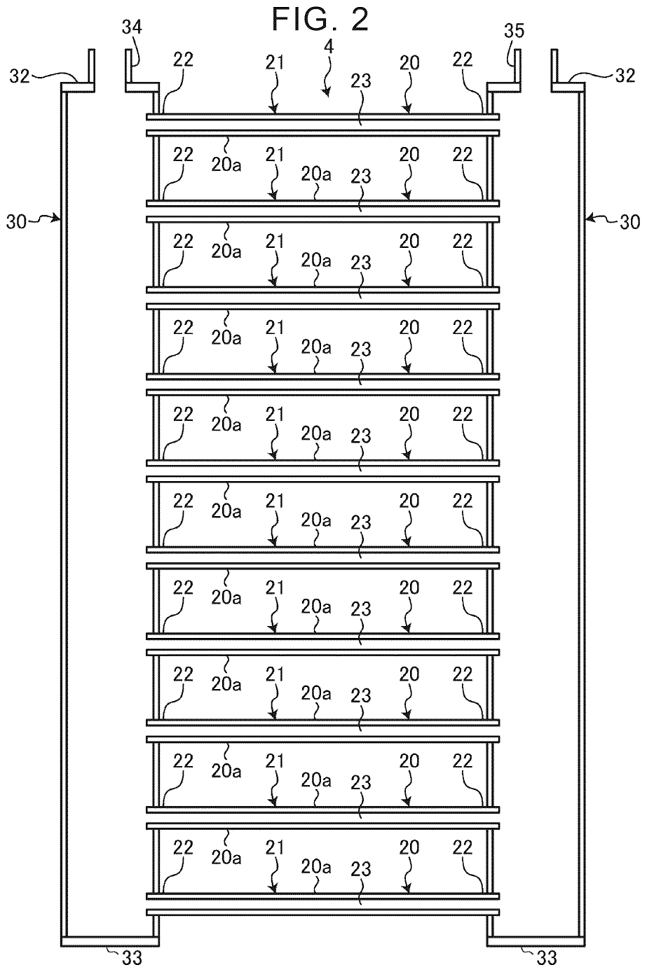

The coolers 20 and the battery cells 2 are stacked alternately, so as to cool the battery cells 2. The coolers 20 are made of metal extrudates. The coolers 20 extend in a Y direction. The coolers 20 have cooling faces 20a that are in contact with the battery cells 2. As illustrated in FIG. 2, the cooling device 4 is an integral structure in which the coolers 20 are joined to the pipes 30, and the coolers 20 have a structure in which the cooling faces 20a face each other. The coolers 20 are configured to be deformable such that the thickness thereof in the X direction increases. FIG. 2 illustrates the coolers 20 prior to deformation, in which the thickness in the X direction is still thin. FIG. 1 illustrates the coolers 20 following deformation, in which the thickness in the X direction has increased. The coolers 20 are fabricated in a thinner state than during use, and are fixed to the pipes 30 by brazing.

As illustrated in FIG. 1, in a state in which the battery pack 1 is completed, a stack is formed inside the case 3 in which the coolers 20 and the battery cells 2 are alternately stacked in the X direction, with coolers 20 located on both ends of the stack in a stacking direction. The stacking direction is the same direction as the X direction. The battery cells 2 are rectangular and the coolers 20 are flat, and accordingly each of the battery cells 2 is interposed between two coolers 20. The battery cells 2 and the coolers 20 are stacked such that the faces thereof having the greatest area among a plurality of surfaces thereof are in contact with each other. The cooling faces 20a are in contact with the flat faces 2a of the battery cells 2. The cooling faces 20a include a first cooling face that is in contact with one of the adjacent battery cells 2, and a second cooling face that is in contact with the other of the adjacent battery cells 2.

Each of the coolers 20 has a cooling portion 21 and connection portions 22.

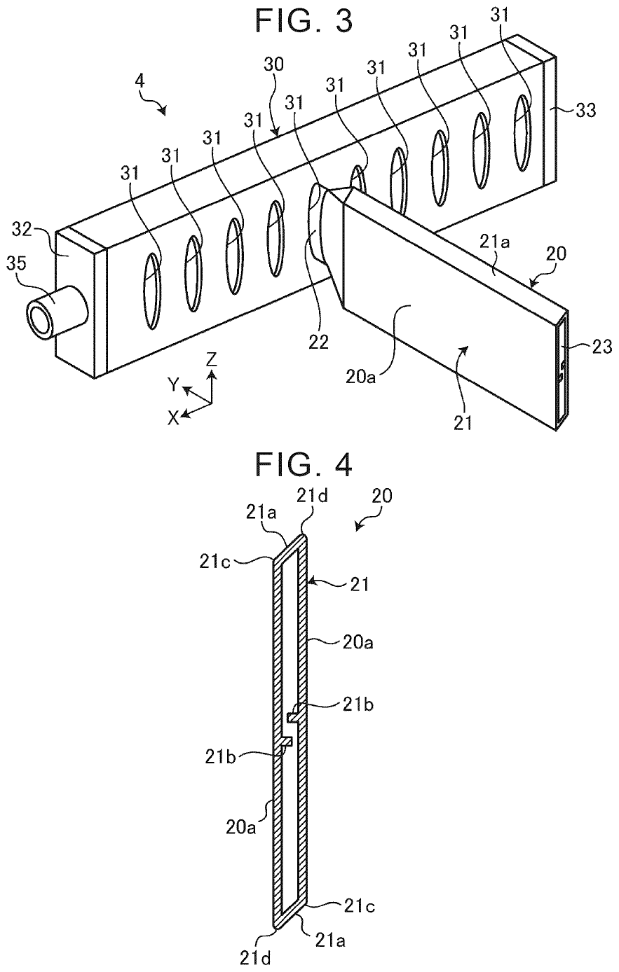

The cooling portion 21 is arranged between the battery cells 2 adjacent to each other in the stacking direction. The cooling portion 21 is a portion including the cooling faces 20a. As illustrated in FIG. 3, the cooling portion 21 is a hollow plate member. A channel 23 through which the coolant flows is provided inside the cooling portion 21. Internal space of the cooling portion 21 is the channel 23 for the coolant. The channel 23 is formed as an internal space in which rear faces of the cooling faces 20a face each other. The cooling portions 21 and the battery cells 2 together form the stack. As illustrated in FIG. 1, in a state in which the cooling device 4 is housed in the case 3, the cooling portions 21 extend in the Y direction that is perpendicular to the X direction. The Y direction is a second direction.

The connection portions 22 are formed on both ends of the cooling portions 21 and are connected to the pipes 30. In the cooling device 4, the coolers 20 are arranged such that the cooling faces 20a thereof face each other, and the connection portions 22 of the coolers 20 are joined to the pipes 30.

The pipes 30 are square pipes extending in the X direction. The pipes 30 are made of metal extrudates. The coolers 20 are connected to the pipes 30. Each of the pipes 30 has a plurality of connection ports 31. The connection ports 31 are openings that open in the Y direction. The pipe 30 is formed by extrusion molding, and the connection ports 31 are opened by machining. The connection ports 31 are connected to the connection portions 22 of the coolers 20. The coolers 20 and the pipes 30 are joined together in a state in which the connection portions 22 are fitted into the connection ports 31.

A first end cap 32 and a second end cap 33 are joined to the each of the pipes 30. The first end cap 32 is joined to the pipe 30 so as to cover one open end of the pipe 30 in the X direction. The second end cap 33 is joined to the pipe 30 so as to cover the other open end of the pipe 30 in the X direction. In the pipes 30, a first pipe section 34 is joined to one of the first end caps 32, and a second pipe section 35 is joined to the other first end cap 32. The first pipe section 34 is an inlet side pipe section. The coolant supplied to the cooling device 4 flows into inside of the cooling device 4 from the first pipe section 34. The second pipe section 35 is an outlet side pipe section. The coolant that is discharged from the cooling device 4 flows out of the cooling device 4 through the second pipe section 35.

In the cooling device 4, the cooling portions 21 are deformable such that the cooling faces 20a are displaced in the X direction in response to the pressure inside the cooler 20. Each of the cooling portions 21 has deforming portions 21a. The deforming portions 21a are portions that deform such that thickness of the cooling portion 21 in the X direction increases. As illustrated in FIG. 3, the deforming portion 21a is formed in a shape that is inclined with respect to the X direction.

FIG. 4 is a diagram for describing the cooling portion. Note that FIG. 4 illustrates a state prior the deforming portions 21a being deformed, that is to say, the shape of the cooler 20 as it is following extrusion molding.

The cooling portion 21 has a parallelogram-shaped external shape as it is following extrusion molding. The cooling portion 21 has protrusions 21b that protrude in the stacking direction from the rear faces of the cooling faces 20a. The protrusions 21b are structures for securing the internal space of the cooling portion 21 during use. Inside the cooling portion 21, a pair of the protrusions 21b is provided on inner faces facing each other in the stacking direction. The protrusions 21b include a first protrusion protruding in the stacking direction from the rear face of one cooling face 20a toward the rear face of the other cooling face 20a, and a second protrusion protruding in the stacking direction from the rear face of the other cooling face 20a toward the rear face of the one cooling face 20a. In a state of the cooling portion 21 as it is following extrusion molding, the protrusions 21b are arranged in a staggered manner.

Each of the deforming portions 21a is inclined with respect to the cooling faces 20a in a state prior to deformation. At both ends of the deforming portion 21a prior to deformation, one corner portion 21c between the deforming portion 21a and the cooling face 20a is formed at an obtuse angle, and another corner 21d between the deforming portion 21a and the cooling face 20a is formed at an acute angle.

In the cooling portion 21, the cooling faces 20a extend along a Z direction prior to and following the deformation. That is to say, in the process of deformation of the deforming portion 21a, the cooling faces 20a maintains a state along the Z direction, such that the cooling portion 21 deforms to become thicker in the X direction.

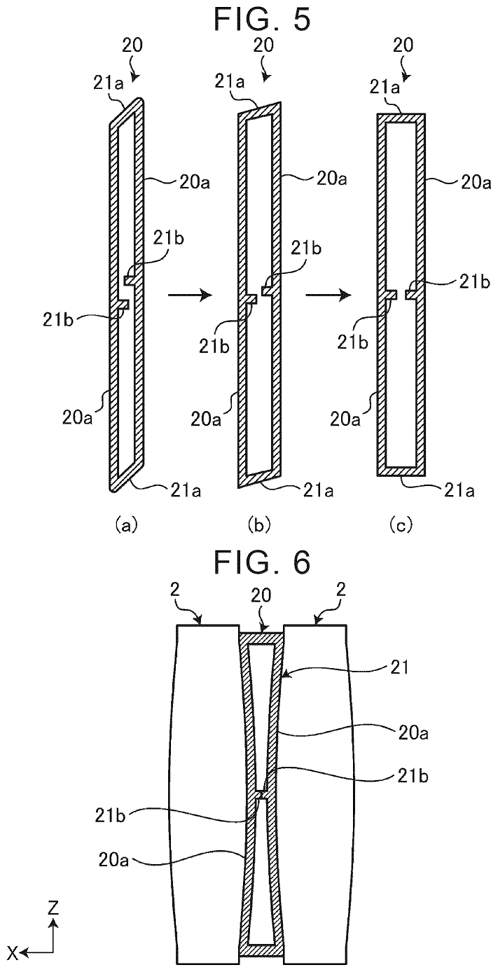

As illustrated in a portion (a) in FIG. 5, in a state prior to the deforming portions 21a being deformed, the thickness of the cooling portion 21 in the X direction is in a thin state. As illustrated in a portion (b) in FIG. 5, in a state in which the deforming portions 21a are in the process of being deformed, the thickness of the cooling portion 21 in the X direction becomes thicker than that prior to the deformation. As illustrated in a portion (c) in FIG. 5, in a state following the deforming portions 21a being deformed, the thickness of the cooling portion 21 in the X direction is in a thick state. When both cooling faces 20a are in facial contact with the flat faces 2a of the battery cells 2, the protrusions 21b face each other in the stacking direction, inside the cooling portion 21. Following the cooler 20 being deformed by application of internal pressure, the Z-direction positions of the protrusions 21b are aligned. In a state following deforming, the deforming portions 21a are perpendicular to the cooling faces 20a. Following deformation, the cooling portion 21 has a rectangular external shape.

As illustrated in FIG. 6, when the battery cells 2 expand and the cooling faces 20a are deformed such that the internal space of the cooling portion 21 becomes narrower, the protrusions 21b abut against each other in a state in which the rear face of one cooling face 20a is spaced apart from the rear face of the other cooling face 20a, inside the cooling portion 21. In a state in which the protrusions 21b abut each other, a load acting on the cooling faces 20a from the battery cells 2 is borne by the protrusions 21b, such that the channel 23 is not crushed and blocked. Once the cooling portion 21 is deformed by expanding, the protrusions 21b support each other, such that the cooling portion 21 does not return to the thin state thereof. Even when the battery cells 2 expand during use, the protrusions 21b that is provided inside the cooling portion 21 support each other, and by the effect thereof, the channel 23 is suppressed from being crushed and becoming blocked.

The manufacturing method of the battery pack 1 includes a joining step, a placement step, a disposing step, and a deformation step. In this manufacturing method, following the battery cells 2 being assembled to the coolers 20, internal pressure is applied to the coolers 20 for expansion of the coolers 20, thereby bringing the coolers 20 and the battery cells 2 into close contact.

The joining step is a process of joining the coolers 20 and the pipes 30 together. In the joining step, the cooling device 4 is formed as an integral structure, and components of the cooling device 4 are joined together such that the cooling faces 20a of the coolers 20 face each other in this structure. The cooling device 4 illustrated in FIG. 2 is formed by the joining step.

The placement step is a step of installing the cooling device 4, which is the integral structure, inside of the case 3. In the placement step, the cooling device 4, which is the integral structure, is placed inside the case 3 in a state in which no battery cells 2 are placed therein.

The disposing step is a step of disposing the battery cells 2 between the coolers 20. In the disposing step, in a state in which the cooling device 4, in which the coolers 20 that are formed such that the cooling faces 20a thereof face each other, is placed inside the case 3, the battery cells 2 are disposed between adjacent coolers 20. Prior to the battery cells 2 being disposed, the coolers 20 are in a thin state. The cooler 20 is formed by extrusion molding into this thin shape.

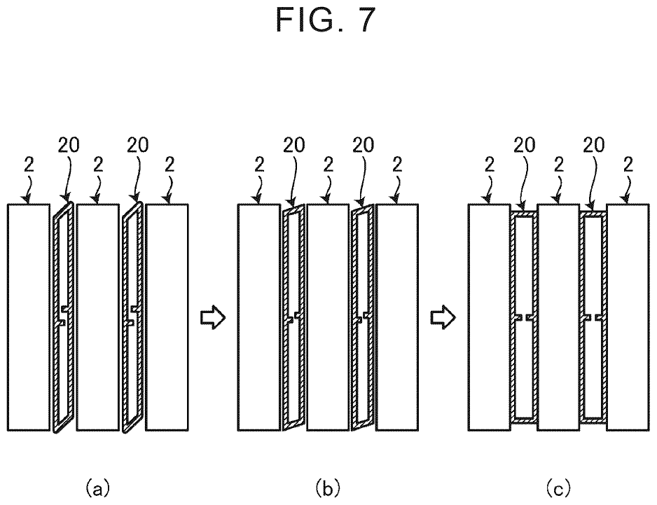

As illustrated in a portion (a) in FIG. 7, in the disposing step, in a state in which the coolers 20 are not deformed, the battery cells 2 are arranged in positions in spaces where the cooling faces 20a face each other and where the flat faces 2a and the cooling faces 20a do not come into contact with each other. The disposing step includes a step of arranging the battery cells 2 in positions where the battery cells 2 and the coolers 20 do not come into contact with each other in a state in which the coolers 20 are not deformed. When the battery cells 2 are disposed, clearances exist between the coolers 20 and the battery cells 2. As illustrated in the portions (a) in FIGS. 7 and 5, inside the coolers 20 prior to deformation in the disposing step, the protrusions 21b do not face each other in the stacking direction.

The deformation step is a step in which the pressure inside the coolers 20 is increased to expand the cooling portions 21. In the deformation step, following the battery cells 2 being disposed between the coolers 20, the pressure inside the coolers 20 is increased to deform the coolers 20 such that the cooling faces 20a come into contact with the battery cells 2.

When pressure begins to be applied to inside of the coolers 20 through the deformation step, the coolers 20 begin to expand, as illustrated in a portion (b) in FIG. 7. When pressure is applied to inside of the coolers 20 in the deformation step, the coolers 20 are in a fully expanded state, as illustrated in a portion (c) in FIG. 7. Inside the coolers 20 following deformation in the deformation step, the protrusions 21b are in a state of facing each other in the stacking direction but also being spaced apart from each other, as illustrated in the portions (c) in FIGS. 7 and 5.

The deformation step also includes a step of abutting the cooling faces 20a against the battery cells 2, to form the stack in which the coolers 20 and the battery cells 2 are stacked, and also compressing the battery cells 2 in the stacking direction of the stack by using the coolers 20.

For example, in the deformation step, following the cooling device 4 being arranged inside the case 3, the second pipe section 35 side is closed using a valve or the like, and the coolant to go inside the coolers 20 is supplied from the first pipe section 34 side using a pump or the like, thereby applying pressure to inside of the coolers 20. As the pressure inside the coolers 20 increases, the deforming portions 21a are deformed such that the channels 23 inside the coolers 20 become wider in the X direction. In the deformation step, the cooling portions 21 are deformed so as to increase the thickness thereof in the X direction, thereby bringing the cooling faces 20a into close contact with the battery cells 2. In the deformation step, the coolers 20 are deformed such that the cooling faces 20a abut the flat faces 2a of the battery cells 2. Following the battery cells 2 being disposed into spaces between the cooling faces 20a that face each other, coolant is supplied from the pump to the first pipe section 34, and the pressure inside the coolers 20 is increased. When pressure inside the coolers 20 increases and the cooling portions 21 are deformed such that the thickness thereof in the X direction increases, the cooling faces 20a can be brought into close contact with the flat faces 2a. In the deformation step, the cooling faces 20a abut against the battery cells 2, so as to form the stack in which the coolers 20 and the battery cells 2 are stacked, and also compressing the battery cells 2 in the stacking direction of the stack by using the coolers 20.

As described above, according to this embodiment, even when the battery cells 2 expand during use, the protrusions 21b provided inside the cooling portion 21 can suppress the channel 23 from being crushed. This ensures a sufficient channel cross-sectional area of the channel 23, and cooling performance can be secured.

Note that the number of battery cells 2 is not limited in particular. The number of battery cells 2 stacked in the X direction is not limited. A structure may be also made in which the battery cells 2 are arranged side by side in the Y direction.

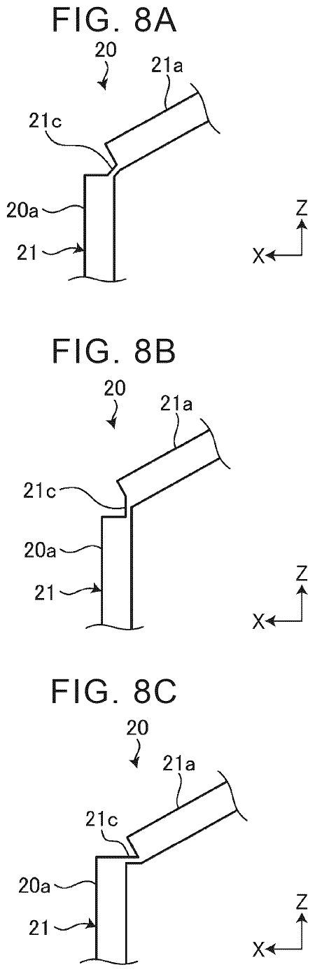

Also, in the cooling portions 21, the thickness of the corner portions 21c and 21d may be thinner than that of the other portions. The corner portions 21c and 21d are provided with thin-walled portions to weaken the cooler 20 when inside of the cooler 20, which is an extrudate, is pressurized, such that the cooler 20 deforms while maintaining the parallelogram outer shape thereof. As illustrated in FIG. 8A, the corner portion 21c is formed as a thin-walled portion extending following the deforming portion 21a. The corner portion 21c is thinner than the deforming portion 21a. The shape of the thin-walled portion is not limited in particular. As illustrated in FIG. 8B, the corner portion 21c may be formed as a thin-walled portion extending along the Z direction. Alternatively, as illustrated in FIG. 8C, the corner portion 21c may be formed as a thin-walled portion extending along the X direction.

What is claimed is:

1. A cooler that is stacked alternately with batteries and cools the batteries, the cooler comprising:
a cooling portion that is arranged between adjacent batteries in a stacking direction, wherein
the cooling portion includes
a channel through which a coolant flows,
a first cooling face that is a cooling face that is in contact with one of the batteries,
a second cooling face that is a cooling face that is in contact with another of the batteries,
a first protrusion that protrudes in the stacking direction from a rear face of the first cooling face toward a rear face of the second cooling face, and
a second protrusion that protrudes in the stacking direction from the rear face of the second cooling face toward the rear face of the first cooling face,
the channel is fashioned from an internal space in which the rear faces of the cooling faces face each other, and
when the first cooling face and the second cooling face are in facial contact with the batteries, the first protrusion and the second protrusion face each other in the stacking direction, inside the cooling portion.

2. The cooler according to claim 1, wherein, when the batteries expand and the cooling faces are deformed such that the internal space becomes narrower, the first protrusion and the second protrusion abut each other, in a state in which the rear face of the first cooling face and the rear face of the second cooling face are spaced apart from each other, inside of the cooling portion.

3. The cooler according to claim 2, wherein, in a state in which the first protrusion and the second protrusion abut each other, a load acting on the cooling faces from the batteries is borne by the first protrusion and the second protrusion, such that the channel is not crushed and blocked.

4. A manufacturing method of a battery pack that includes the cooler according to claim 1, the manufacturing method comprising:
disposing battery cells between adjacent coolers, in a state in which a cooling device that is fabricated of a plurality of the coolers such that cooling faces of the coolers face each other, is placed inside a case that houses the battery cells; and
increasing pressure inside of the coolers following the battery cells being disposed between the coolers, and deforming the coolers such that the cooling faces come into contact with the battery cells, wherein
inside of each of the coolers prior to deformation in the disposing, the first protrusion and the second protrusion do not face each other in the stacking direction, and
inside of each of the coolers following deformation in the deforming, the first protrusion and the second protrusion face each other in the stacking direction.

5. The manufacturing method according to claim 4, wherein:
the disposing includes arranging the battery cells inside the case at positions where the battery cells do not come into contact with the cooling faces in a state in which the coolers are not deformed;
the deforming includes abutting the cooling faces against the battery cells to make a stack in which the coolers and the battery cells are stacked, and also compressing the battery cells in the stacking direction of the stack by using the coolers; and
inside the coolers following deformation in the deforming, the first protrusion and the second protrusion are in a state of being spaced apart from each other.
